(19) United States
(12) Patent Application Publication
(10) Pub. No.: US 2015/0282017 A1
(43) Pub. Date: Oct. 1, 2015

(54) Method and system for realizing mobility management of evolved packet core network

(71) Applicant: ZTE CORPORATION, Shenzhen, Guangdong (CN)

(72) Inventors: Jing Wang, Shenzhen (CN); Na Zhou, Shenzhen (CN); Shuang Liang, Shenzhen (CN)

(21) Appl. No.: 14/435,143

(22) PCT Filed: Oct. 9, 2013
(86) PCT No.: PCT/CN2013/084920

§ 371 Date: Apr. 10, 2015

(30) Foreign Application Priority Data
Oct. 11, 2012 (CN) 201210384526.5

(51) Int. Cl. H04W 36/00; H04W 72/04; H04L 12/741; H04W 36/30; H04W 36/32

(52) U.S. Cl. CPC H04W 36/0033; H04W 36/30; H04W 36/32; H04L 45/745; H04W 72/0406; H04W 88/08

(57) ABSTRACT

A method for realizing mobility management of an Evolved Packet Core (EPC) network is described. A first control network element addresses a second control network element according to an identification or address information of the second control network element sent from a first Mobility Management Entity (MME), acquires an address of a Public Data Network (PDN) Gateway (PGW) and Tunnel Endpoint Identification (TEID) information of the PGW allocated by the second control network element, and sends to the second control network element an address of a first Serving Gateway (SGW) and TEID information of the first SGW allocated thereby; the first control network element sends to the first SGW flow table information including the address of the PGW and the TEID information of the PGW; and the second control network element sends to the PGW flow table information including the address of the first SGW and the TEID information of the first SGW. A system for realizing mobility management of an EPC network is also described. Coordination problems of two control network elements caused by changes of the control network elements due to a movement of a UE can be solved by the solution of the embodiments of the disclosure.

### TECHNICAL FIELD

The disclosure relates to a mobility management technology of the 3^{rd} Generation Partnership Project (3GPP), in particular to a method and system for realizing mobility management of an Evolved Packet Core (EPC) network.

### BACKGROUND

The Open Flow protocol, proposed by Stanford University of the USA in 2008, applies a forwarding/control separation framework. An external control plane entity applies the Open Flow protocol to control a forwarding plane device to realize various forwarding logics while the major function of the forwarding plane device is to implement controlled forwarding according to a flow table sent from an Open Flow controller. Behaviors of the forwarding plane device are standardized, for example, the forwarding plane device receives a message, extracts an L2/L3/L4 related field value of a message header as a keyword searching the flow table, after a table item is matched, performs conversion to a message field according to an instruction set in a content of the table item, and then forwards the converted message field to a certain logic or physical port according to an indication. The protocol is further evolved into a Software Defined Network (SDN) technology, which means that various complicated network applications can be realized by software programming on a control plane, while no changes are required by a forwarding plane device. Since the control plane applies a general server plus a general operating system, and can be implemented both by a general software programming and by a scripting language such as Python, it becomes very simple to support a new internet protocol, and deployment periods of new technologies are greatly shortened.

An EPC network, which is a new packet core network introduced by 3GPP R8, further flattens a network, and forwarding plane devices are divided into Serving Gateways (SGW) and Public Data Network (PDN) Gateways (PGW). Ever since R8, a series of functions have been enhanced by the EPC network, including the introduction of technologies including flow division etc. The enhancement of these functions needs a period of 1 to 2 years for establishing new protocol specifications which will be then implemented by device providers, tested by operators and then deployed, which results in a very long period for introducing new network characteristics with high cost. Nevertheless, targets designed by the Open Flow protocol can exactly solve this problem, and it only needs to modify logics of control network elements in the Open Flow mechanism to introduce new network characteristics. Such a function is implemented by a forwarding plane device controlled by a control network element. However, the Open Flow protocol is mainly designed to be applied in a two-layer switched network at present. An EPC network device, which needs to perform service control, cannot be supported directly and needs to be expanded to some extent. In a network architecture, the introduction of the Open Flow mechanism has a certain impact on user plane network element functions and control modes of the existing EPC network. FIG. 1 shows a schematic diagram illustrating an EPC network architecture introducing the Open Flow mechanism in the related art. As shown in FIG. 1, the network architecture includes a User Equipment (UE) 10, an Evolved NodeB (eNB) 20, a Mobility Management Entity (MME) 30, an SGW 40, a PGW 50 and a control network element 60, wherein the UE 10 and the eNB 20 are connected, the eNB 20, the MME 30 and the SGW 40 are connected, the MME 30 and the control network element 60 are connected, and the control network element 60 controls the SGW 40 and the PGW 50.

The SGW and the PGW in FIG. 1 only have a user plane function and all control plane management functions are completed by the control network element, including establishment and modification of a user plane tunnel, and Quality of Service (QoS) guarantee etc. All control logics required by the SGW and the PGW are sent by the control network element, and the SGW and the PGW are actually routers having identical functions and have functions of an SGW and a PGW under the control of the control network element. This can realize more flexible networking for an EPC core network.

A mobility management mechanism is a processing mechanism adopted by the EPC network to maintain the continuity of user services. When a UE moves, the EPC network ensures that an anchor PGW is not changed. In the case that an eNB attached by the UE and an SGW serving for the UE changes, the EPC network modifies uplink and downlink tunnel paths to maintain data transmission of UE services. After the instruction of the Open Flow mechanism, transfer of tunnel paths needs to be completed by a control network element under the control of the EPC network so as to ensure the continuity of the UE services. When the UE moves, if a control network element serving for the UE does not change, tunnel management can be completed by a forwarding device controlled by this control network element according to the Open Flow mechanism, specifically taking a Tracking Area Update (TAU) process as an example, as shown in FIG. 2.

FIG. 2 is an implementation process of a TAU process in which both a control network element and an SGW are not changed.

Step 101: a UE initiates a TAU request;

Step 102: a first MME serving for the UE acquires a context from a second MME, acquires a bearer context managed by the second MME for the UE and control network element information for managing a core network tunnel for the UE;

the first MME is an MME reselected by an eNB after the location of the UE changes, and the second MME is an original MME before the location of the UE changes; Step 103: the first MME determines, according to the location of the UE, whether a control network element needs to be re-designated to serve for the UE; if not, step 104 is executed; otherwise, the process is over;

Step 104: the first MME initiates a modification bearer request message to update registration information of the MME to the control network element; the modification bearer request message includes a control plane address and a Tunnel Endpoint Identification (TEID) of the first MME;

Step 105: the control network element determines, according to the location of the UE, whether an SGW needs to be re-designated; if not, step 106 is executed; otherwise, the process is over;

Step 106: when there are uplink data which needs to be transmitted in the UE during the TAU process, the first MME initiates a wireless bearer setup process; the wireless bearer setup process is implemented by an initial context setup process; the eNB allocates a downlink TEID bore by the UE;

Step 107: the first MME sends the modification bearer request message to the control network element and the message includes an address of the eNB and a TEID allocated by the eNB for the UE;

Step 108: the control network element updates a downlink flow table message including the address and the TEID of the eNB etc. to the SGW through sending a flow table message, and the SGW sends data to a new eNB.

Nonetheless, at present, there is no clear solution for two control network elements to perform function location and coordination when the control network elements change due to the movement of the UE.

### SUMMARY

In view of this, the main purpose of embodiments of the disclosure is to provide a method and system for realizing mobility management of an EPC network so as to solve coordination problems of two control network elements caused by changes of the control network elements due to the movement of a UE.

To realize the purpose above, the technical solution of embodiments of the disclosure is realized as follows.

An embodiment of the disclosure provides a method for realizing mobility management of an EPC network. The method includes:

when a control network element changes, addressing, by a first control network element, a second control network element according to an identification or address information of the second control network element sent from a first Mobility Management Entity (MME), acquiring an address of a Public Data Network (PDN) Gateway (PGW) and Tunnel Endpoint Identification (TEID) information of the PGW allocated by the second control network element, and sending to the second control network element an address of a first Serving Gateway (SGW) and TEID information of the first SGW allocated thereby;

sending, by the first control network element, to the first SGW flow table information including the address of the PGW and the TEID information of the PGW; and

sending, by the second control network element, to the PGW flow table information including the address of the first SGW and the TEID information of the first SGW.

Preferably, the method may further include: selecting, by the first MME, the first control network element according to a current access location of a User Equipment (UE) or location information of a first Evolved NodeB (eNB), and sending to the selected first control network element a creation session request message to establish a General Packet Radio Service (GPRS) Tunneling Protocol (GTP) tunnel, wherein the creation session request message includes location information of the UE, and the identification or the address information of the second control network element.

Preferably, the method may further include: before selecting the first control network element by the first MME,

after the UE leaves an area defined by a Tracking Area Identity (TAI) list, selecting, by the first eNB, the first MME for the UE; sending, by the UE, to the first MME a Tracking Area Update (TAU) request; finding, by the first MME, a second MME according to a Globally Unique Temporary UE Identity (GUTI) and sending to the second MME a context acquisition message; replying, by the second MME, to the first MME context information of the UE and information of the second control network element serving for the UE;

or, determining, by a second eNB, that the second eNB cannot serve for the UE any more according to measurement information reported by the UE; sending, by the second eNB, to the second MME a handover request message including identification information of the first eNB for handover; selecting, by the second MME, the first MME according to the identification information of the first eNB and a topological relation, and sending to the first MME the location information of the first eNB, a mobility management and bearer context of the UE and information of the second control network element serving for the PGW.

Preferably, the method may further include: when there are uplink data to be sent in the UE during a TAU process, establishing, by the first MME, a bearer of an air interface and initiating an initial context setup process to acquire an address of the first eNB and a TEID of the first eNB; sending, by the first MME, to the first control network element a modification bearer request message including the address of the first eNB and the TEID of the first eNB; sending, by the first control network element, to the first SGW a flow table including the address of the first eNB and the TEID of the first eNB and updating downlink GTP tunnel information.

Preferably, the method may further include: when data between base stations need to be forwarded directly, acquiring, by the first control network element, from the first MME an address of the first eNB and a TEID of the first eNB, sending the flow table information including the address of the first eNB and the TEID of the first eNB to the first SGW, and notifying the second control network element to update the flow table information on the PGW; after receiving the notification, sending, by the second control network element, the acquired address of the first SGW and the acquired TEID information of the first SGW to the PGW; updating, by the PGW, flow table information of itself according to the address of the first SGW and the TEID information of the first SGW; after the updating, transmitting uplink and downlink data among the first eNB, the first SGW and the PGW.

Preferably, the method may further include: when uplink data between base stations need to be forwarded indirectly, acquiring, by the first control network element, from the first MME an address of the first eNB and a TEID of the first eNB, designating a third SGW for forwarding data and sending to the third SGW a flow table including the address of the first eNB and the TEID of the first eNB; sending, by the first control network element, to the first MME an address of the third SGW and a TEID of the third SGW; forwarding, by the first MME, to the second MME the address of the third SGW and the TEID of the third SGW; notifying, by the second MME, the address of the third SGW and the TEID of the third SGW to the second control network element and the second eNB; notifying, by the second control network element, the address of the third SGW and the TEID of the third SGW to the first SGW; and transmitting the uplink data among the second eNB, the third SGW and the first eNB.

Preferably, the method may further include: when downlink data between base stations need to be forwarded indirectly, acquiring, by the first control network element, from the first MME an address of the first eNB and a TEID of the first eNB, sending the flow table information including the address of the first eNB and the TEID of the first eNB to the first SGW, and notifying the second control network element to update the flow table information on the PGW; after receiving the notification, sending, by the second control network element, to the PGW the acquired address of the first SGW and the acquired TEID of the first SGW; updating, by the PGW, flow table information of itself according to the address of the first SGW and the TEID information of the first SGW; after the updating, transmitting the downlink data among the first eNB, the first SGW and the PGW.

Preferably, the method may further include: sending, by the first MME or the second MME, to the second control network element a deleting session request message; deleting, by the second control network element, user flow table information in the second SGW by deleting the flow table information to recover resources.

An embodiment of the disclosure further provides a system for realizing mobility management of an EPC network. The system includes: a first control network element, a second control network element, a first Mobility Management Entity (MME), a first Serving Gateway (SGW) and a Public Data Network (PDN) Gateway (PGW), wherein

the first control network element is configured to address the second control network element according to an identification or address information of the second control network element sent from the first MME, to acquire an address of the PGW and Tunnel Endpoint Identification (TEID) information of the PGW allocated by the second control network element, and to send to the second control network element an address of the first SGW and TEID information of the first SGW allocated thereby; and to send to the first SGW flow table information including the address of the PGW and the TEID information of the PGW;

the second control network element is configured to send to the PGW flow table information including the address of the first SGW and the TEID information of the first SGW.

Preferably, the system may further include a first eNB which is configured to be attached by a User Equipment (UE);

the first MME may be configured to select the first control network element according to a current access location of the UE or location information of the first Evolved NodeB (eNB), and to send to the selected first control network element a creation session request message to establish a General Packet Radio Service (GPRS) Tunneling Protocol (GTP) tunnel, wherein the creation session request message may include location information of the UE, and the identification or the address information of the second control network element.

Preferably, the system may further include: a second MME which is configured to reply to the first MME context information of the UE and information of the second control network element serving for the UE;

the first eNB may be further configured to select the first MME for the UE;

the first MME may be further configured to find the second MME according to a Globally Unique Temporary UE Identity (GUTI) and to send to the second MME a context acquisition message;

or, the system may further include: a second eNB and a second MME, wherein

the second eNB is configured to determine, according to measurement information reported by the UE, that the second eNB cannot serve for the UE any more; and to send to the second MME a handover request message including identification information of the first eNB for handover;

the second MME is configured to select the first MME according to the identification information of the first eNB and a topological relation, and to send to the first MME the location information of the first eNB, a mobility management and bearer context of the UE and information of the second control network element serving for the PGW.

Preferably, the first MME may be further configured, when there are uplink data to be sent in the UE during a TAU process, to establish a bearer of an air interface, and to initiate an initial context setup process to acquire an address of the first eNB and a TEID of the first eNB; and to send to the first control network element a modification bearer request message including the address of the first eNB and the TEID of the first eNB;

accordingly, the first control network element may be further configured to send to the first SGW a flow table including the address of the first eNB and the TEID of the first eNB, and to update downlink GTP tunnel information.

Preferably, the first control network element may be further configured, when data between base stations need to be forwarded directly, to acquire from the first MME an address of the first eNB and a TEID of the first eNB, to send the flow table information including the address of the first eNB and the TEID of the first eNB to the first SGW, and to notify the second control network element to update the flow table information on the PGW;

accordingly, the second control network element may be further configured, after receiving the notification, to send the acquired address of the first SGW and the acquired TEID information of the first SGW to the PGW;

accordingly, the PGW may be configured to update flow table information of itself according to the address of the first SGW and the TEID information of the first SGW; after the updating, uplink and downlink data are transmitted among the first eNB, the first SGW and the PGW.

Preferably, the first control network element may be further configured, when uplink data between base stations need to be forwarded indirectly, to acquire from the first MME an address of the first eNB and a TEID of the first eNB, to designate a third SGW for forwarding data, and to send to the third SGW a flow table including the address of the first eNB and the TEID of the first eNB; and to send to the first MME an address of the third SGW and a TEID of the third SGW;

accordingly, the first MME may be further configured to forward to the second MME the address of the third SGW and the TEID of the third SGW;

accordingly, the second MME may be configured to notify the address of the third SGW and the TEID of the third SGW to the second control network element and the second eNB;

accordingly, the second control network element may be further configured to notify the address of the third SGW and the TEID of the third SGW to the first SGW; and the uplink data may be transmitted among the second eNB, the third SGW and the first eNB.

Preferably, the first control network element may be further configured, when downlink data between base stations need to be forwarded indirectly, to acquire from the first MME an address of the first eNB and a TEID of the first eNB, to send the flow table information including the address of the first eNB and the TEID of the first eNB to the first SGW, and to notify the second control network element to update the flow table information on the PGW;

accordingly, the second control network element may be further configured, after receiving the notification, to send to the PGW the acquired address of the first SGW and the acquired TEID of the first SGW;

accordingly, the PGW may be configured to update flow table information of itself according to the address of the first SGW and the TEID information of the first SGW; after the updating, the downlink data may be transmitted among the first eNB, the first SGW and the PGW.

Preferably, the system may further include a second SGW; the first MME or the second MME may be further configured to send to the second control network element a deleting session request message;

accordingly, the second control network element may be further configured to delete user flow table information in the second SGW by deleting the flow table information to recover resources.

The embodiments of the disclosure provide a method for realizing mobility management of an EPC network. When a control network element changes during the movement of a UE, a first control network element addresses a second control network element according to an identification or address information of the second control network element sent from a first MME, acquires an address of a PGW and TEID information of the PGW allocated by the second control network element, and sends to the second control network element an address of a first SGW and TEID information of the first SGW allocated thereby; the first control network element sends to the first SGW flow table information including the address of the PGW and the TEID information of the PGW; and the second control network element sends to the PGW flow table information including the address of the first SGW and the TEID information of the first SGW. Thus, coordination problems of two control network elements caused by changes of the control network elements due to the movement of the UE can be solved.

### BRIEF DESCRIPTION OF THE DRAWINGS

FIG. 1 is a schematic diagram illustrating an EPC network architecture introducing an Open Flow mechanism in the related art;

FIG. 2 is a flowchart of a mobility management method in which a control network element is not changed in a TAU process of an EPC network in the related art;

FIG. 3 is a flowchart of a method for realizing mobility management of an EPC network in the first embodiment of the disclosure;

FIG. 4 is a structural diagram of a system for realizing mobility management of an EPC network in the first embodiment of the disclosure;

FIG. 5 is a flowchart of a method for realizing mobility management of an EPC network in the second embodiment of the disclosure;

FIG. 6 is a flowchart of a method for realizing mobility management of an EPC network in the third embodiment of the disclosure;

FIG. 7 is a flowchart of a method for realizing mobility management of an EPC network in the fourth embodiment of the disclosure;

FIG. 8 is a flowchart of a method for realizing direct data forwarding among base stations based on the fourth embodiment of the disclosure; and

FIG. 9 is a flowchart of a method for realizing indirect data forwarding among base stations based on the fourth embodiment of the disclosure.

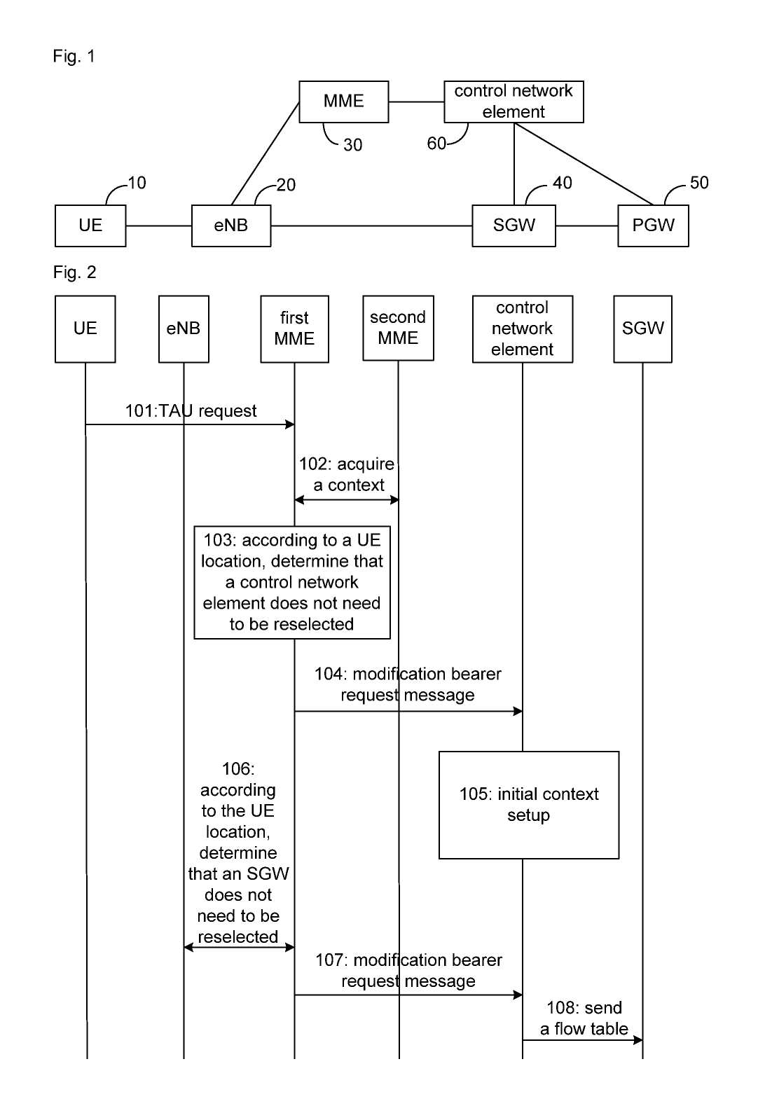

### DETAILED DESCRIPTION

The basic idea of embodiments of the disclosure is that: when a control network element changes during a movement of a UE, a first control network element addresses a second control network element according to an identification or address information of the second control network element sent from a first MME, acquires an address of a PGW and TEID information of the PGW allocated by the second control network element, and sends to the second control network element an address of a first SGW and TEID information of the first SGW allocated thereby; the first control network element sends flow table information including the address of the PGW and the TEID information of the PGW to the first SGW; and the second control network element sends flow table information including the address of the first SGW and the TEID information of the first SGW to the PGW.

Here, the first control network element refers to a control network element after the control network element changes; the second control network element refers to an original control network element before the control network element changes; the first SGW refers a new SGW selected by the first control network element.

The disclosure will be further described in details below through the drawings and specific embodiments.

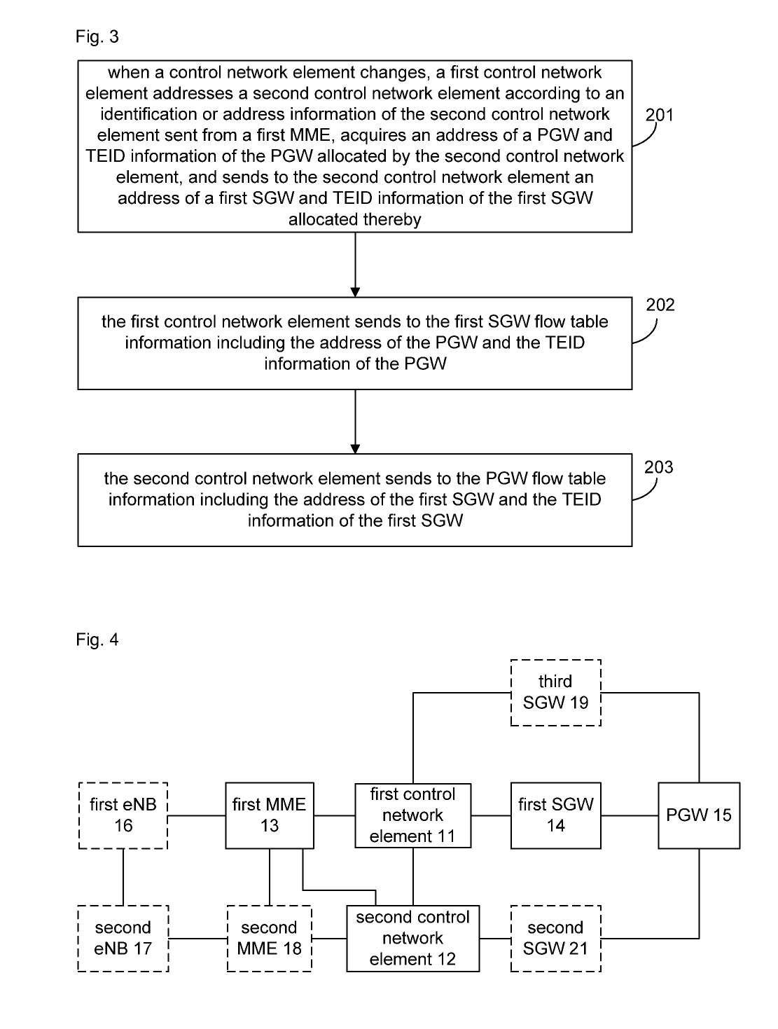

An embodiment of the disclosure realizes a method for realizing mobility management of an EPC network. FIG. 3 is a flowchart of a method for realizing mobility management of an EPC network in the first embodiment of the disclosure. As shown in FIG. 3, the method includes several steps as follows:

Step 201: when a control network element changes during a movement of a UE, a first control network element addresses a second control network element according to an identification or address information of the second control network element sent from a first MME, acquires an address of a PGW and TEID information of the PGW allocated by the second control network element, and sends an address of a first SGW and TEID information of the first SGW allocated thereby to the second control network element ;

the step may specifically include: when the control network element changes during the movement of the UE, the first control network element receives from the first MME a creation session request message including the identification or the address information of the second control network element, addresses the second control network element according to the identification or the address information of the second control network element, and acquires the address of the PGW and the TEID information of the PGW allocated by the second control network element; wherein the creation session request further includes location information of the UE; the first control network element allocates the first SGW according to the location information of the UE, and sends the address of the first SGW and the TEID information of the first SGW to the second control network element;

the step further includes: the first MME selects the first control network element according to a current access location of the UE or location information of a first eNB, and sends to the selected first control network element a creation session request message to establish a GTP tunnel, wherein the creation session request message includes location information of the UE, and the identification or the address information of the second control network element.

The selecting the first control network element according to the current access location of the UE or the location information of the first eNB by the first MME includes: when a handover does no occur to an eNB, the first MME determines, according to context information of the UE and information of the second control network element serving for the UE, that the current access location of the UE changes, and that the UE has exceeded a control area of the second control network element, and reselects a first control network element; when a handover occurs to the eNB, the first MME reselects a first control network element when determining that the location information of the first eNB has exceeded the control area of the second control network element;

before selecting the first control network element by the first MME, the step further includes: after the UE leaves an area defined by a TAI list, the first eNB selects the first MME for the UE; the UE sends to the first MME a TAU request; the first MME finds a second MME according to a GUTI and sends to the second MME a context acquisition message; the second MME replies to the first MME context information of the UE and information of the second control network element serving for the UE; the context information includes: a mobility management context and a session management context;

or a second eNB determines, according to measurement information reported by the UE, that the second eNB cannot serve for the UE any more; the second eNB sends to the second MME a handover request message including identification information of the first eNB for handover; the second MME selects the first MME according to the identification information of the first eNB and a topological relation, and sends to the first MME the location information of the first eNB, a mobility management and bearer context of the UE and information of the second control network element serving for the PGW.

Further, the second MME identifies the second control network element to serve for the PGW, and the first MME identifies the first control network element to serve for the SGW;

Step 202: the first control network element sends to the first SGW flow table information including the address of the PGW and the TEID information of the PGW;

Step 203: the second control network element sends to the PGW flow table information including the address of the first SGW and the TEID information of the first SGW.

The method further includes: when there are uplink data to be sent in the UE during a TAU process, the first MME establishes a bearer of an air interface and initiates an initial context setup process to acquire an address of the first eNB and a TEID of the first eNB; the first MME sends to the first control network element a modification bearer request message including the address of the first eNB and the TEID of the first eNB; the first control network element sends to the first SGW a flow table including the address of the first eNB and the TEID of the first eNB, and updates downlink GTP tunnel information.

The method further includes: the first MME or the second MME sends to the second control network element a deleting session request message; the second control network element deletes user flow table information in the second SGW by deleting the flow table information so as to recover resources.

The method further includes: when data between base stations need to be forwarded directly, the first control network element acquires from the first MME an address of the first eNB and a TEID of the first eNB, sends the flow table information including the address of the first eNB and the TEID of the first eNB to the first SGW, and notifies the second control network element to update the flow table information on the PGW; after receiving the notification, the second control network element sends the acquired address of the first SGW and the acquired TEID of the first SGW to the PGW; the PGW updates flow table information of itself according to the address of the first SGW and the TEID of the first SGW; after the updating, uplink and downlink data are transmitted among the first eNB, the first SGW and the PGW.

The method further includes: when uplink data between base stations need to be forwarded indirectly, the first control network element acquires from the first MME an address of the first eNB and a TEID of the first eNB, designates a third SGW for forwarding data, and sends to the third SGW a flow table including the address of the first eNB and the TEID of the first eNB; the first control network element further sends to the first MME an address of the third SGW and a TEID of the third SGW; the first MME forwards to the second MME the address of the third SGW and the TEID of the third SGW; the second MME notifies the address of the third SGW and the TEID of the third SGW to the second control network element and the second eNB; the second control network element notifies the address of the third SGW and the TEID of the third SGW to the first SGW; and the uplink data are transmitted among the second eNB, the third SGW and the first eNB.

When downlink data between base stations need to be forwarded indirectly, the first control network element acquires from the first MME an address of the first eNB and a TEID of the first eNB, sends the flow table information including the address of the first eNB and the TEID of the first eNB to the first SGW, and notifies the second control network element to update the flow table information on the PGW; after receiving the notification, the second control network element sends to the PGW the acquired address of the first SGW and the acquired TEID of the first SGW; the PGW updates flow table information of itself according to the address of the first SGW and the TEID of the first SGW; after the updating, the downlink data are transmitted among the first eNB, the first SGW and the PGW.

To realize the above method, the disclosure further provides a system for realizing mobility management of an EPC network. FIG. 4 is a structural diagram of a system for realizing mobility management of an EPC network in the first embodiment of the disclosure. As shown in FIG. 4, when a control network element changes during a movement of a UE, the system includes: a first control network element 11, a second control network element 12, a first MME 13, a first SGW 14 and a PGW 15, wherein

the first control network element 11 is configured to address the second control network element 12 according to an identification or address information of the second control network element 12 sent from the first MME 13, to acquire an address of the PGW 15 and TEID information of the PGW 15 allocated by the second control network element 12, and to send to the second control network element 12 an address of the SGW 14 and TEID information of the first SGW 14 allocated thereby; and to send to the first SGW 14 flow table information including the address of the PGW 15 and the TEID information of the PGW 15;

the second control network element 12 is configured to send to the PGW 15 flow table information including the address of the first SGW 14 and the TEID information of the first SGW 14.

the first control network element 11 is configured to receive from the first MME 13 a creation session request message including the identification or the address information of the second control network element 12, to address the second control network element 12 according to the identification or the address information of the second control network element 12, and to acquire the address of the PGW 15 and the TEID information of the PGW 15 allocated by the second control network element 12; the creation session request further includes location information of the UE; the first control network element 11 is configured to allocate the first SGW 14 according to the location information of the UE, and to send the address of the first SGW 14 and the TEID information of the first SGW 14 to the second control network element;

the system further includes a first eNB 16 which is configured to be attached by a UE;

the first MME 13 is configured to select the first control network element 11 according to a current access location of the UE or location information of the first eNB 16, and to send to the selected first control network element 11 a creation session request message to establish a GTP tunnel, wherein the creation session request message includes location information of the UE, and the identification or the address information of the second control network element 12.

The system further includes: a second MME 18 which is configured to reply to the first MME 13 context information of the UE and information of the second control network element 12 serving for the UE;

the first eNB 16 is further configured to select the first MME 13 for the UE;

the first MME 13 is further configured to find the second MME 18 according to a GUTI, and to send to the second MME 18 a context acquisition message; the context information includes: a mobility management context and a session management context;

or, the system further includes: a second eNB 17 and a second MME 18, wherein

the second eNB 17 is configured to determine, according to measurement information reported by the UE, that the second eNB cannot serve for the UE any more; the second eNB 17 sends to the second MME 18 a handover request message including identification information of the first eNB 16 for handover;

the second MME 18 is configured to select the first MME 13 according to the identification information of the first eNB 16 and a topological relation, and to send to the first MME 13 the location information of the first eNB 16, a mobility management and bearer context of the UE and information of the second control network element 12 serving for the PGW 15.

The first MME 13 is further configured, when there are uplink data to be sent in the UE during a TAU process, to establish a bearer of an air interface, and to initiate an initial context setup process to acquire an address of the first eNB 16 and a TEID of the first eNB 16; the first MME 13 is configured to send to the first control network element 11 a modification bearer request message including the address of the first eNB 16 and the TEID of the first eNB 16;

accordingly, the first control network element 11 is further configured to send to the first SGW 14 a flow table including the address of the first eNB 16 and the TEID of the first eNB 16, and to update downlink GTP tunnel information.

The first control network element 11 is further configured, when data between base stations need to be forwarded directly, to acquire from the first MME 13 an address of the first eNB 16 and a TEID of the first eNB 16, to send the flow table information including the address of the first eNB and the TEID of the first eNB to the first SGW 14, and to notify the second control network element 12 to update the flow table information on the PGW 15;

accordingly, the second control network element 12 is further configured, after receiving the notification, to send the acquired address of the first SGW 14 and the acquired TEID of the first SGW 14 to the PGW 15;

accordingly, the PGW 15 is configured to update the flow table information of itself according to the address of the first SGW 14 and the TEID of the first SGW 14; after the updating, uplink and downlink data are transmitted among the first eNB 16, the first SGW 14 and the PGW 15.

The system further includes a third SGW 19. The first control network element 11 is further configured, when uplink data between base stations need to be forwarded indirectly, to acquire from the first MME 13 an address of the first eNB 16 and a TEID of the first eNB 16, to designate the third SGW 19 for forwarding data, and to send to the third SGW 19 a flow table including the address of the first eNB 16 and the TEID of the first eNB 16; the first control network element 11 is further configured to send to the first MME 13 an address of the third SGW 19 and a TEID of the third SGW 19;

accordingly, the first MME 13 is further configured to forward to the second MME 18 the address of the third SGW 19 and the TEID of the third SGW 19;

accordingly, the second MME 18 is configured to notify the address of the third SGW 19 and the TEID of the third SGW 19 to the second control network element 12 and the second eNB 17;

accordingly, the second control network element 12 is further configured to notify the address of the third SGW 19 and the TEID of the third SGW 19 to the first SGW 14; and the uplink data are transmitted among the second eNB 17, the third SGW 19 and the first eNB 16.

Preferably, the first control network element 11 is further configured, when downlink data between base stations need to be forwarded indirectly, to acquire from the first MME 13 an address of the first eNB 16 and a TEID of the first eNB 16, to send the flow table information including the address of the first eNB 16 and the TEID of the first eNB 16 to the first SGW 14, and to notify the second control network element 12 to update the flow table information on the PGW 15;

accordingly, the second control network element 12 is further configured, after receiving the notification, to send to the PGW 15 the acquired address of the first SGW 14 and the acquired TEID of the first SGW 14;

accordingly, the PGW 15 is configured to update flow table information of itself according to the address of the first SGW 14 and the TEID of the first SGW 14; after the updating, the downlink data are transmitted among the first eNB 16, the first SGW 14 and the PGW 15.

Preferably, the system further includes a second SGW 20; the first MME 13 or the second MME 18 is further configured to send to the second control network element 12 a deleting session request message;

accordingly, the second control network element 12 is further configured to delete user flow table information in the second SGW 20 by deleting the flow table information so as to recover resources.

Implementation processes and principles of the method of the disclosure will be described in details below in conjunction with specific embodiments.

### Embodiment 1

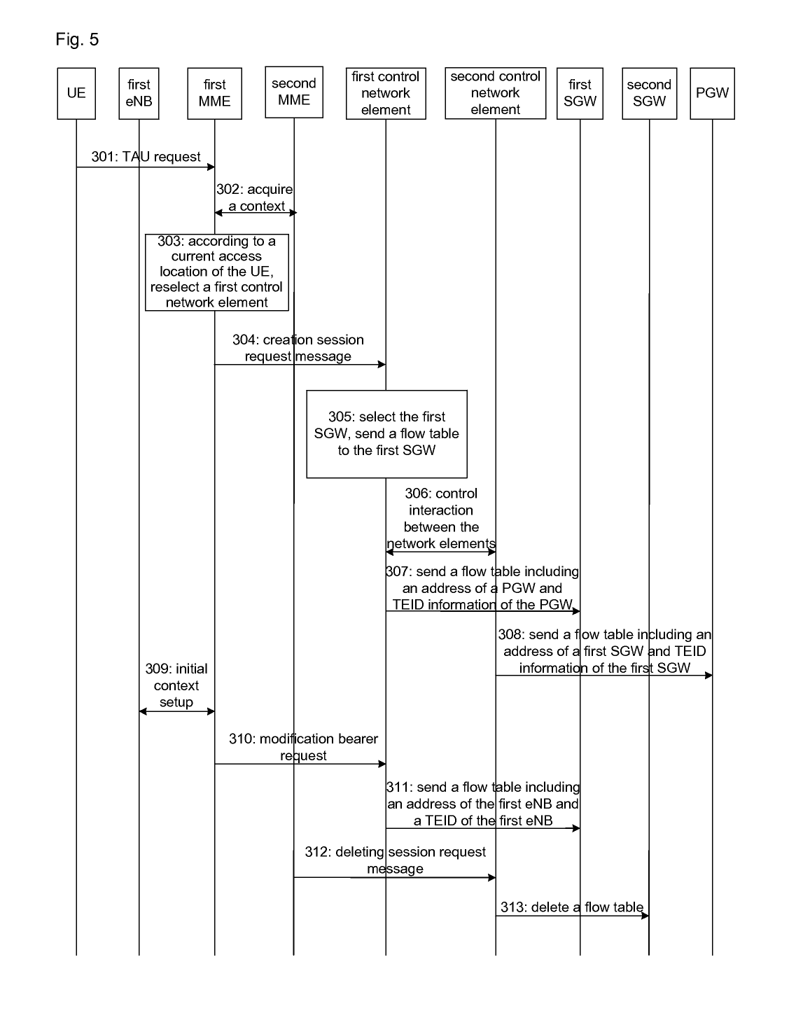

FIG. 5 shows a method for realizing mobility management of an EPC network in the embodiment. As shown in FIG. 5, the method includes:

Step 301: after leaving an area defined by a TAI list, a UE initiates a TAU request;

Step 302: a first MME which is selected by a first eNB for the UE finds a second MME according to a GUTI, and sends to the second MME a context acquisition message; the second MME replies context information of the UE and information of a second control network element serving for the UE; wherein the context information includes a mobility management context and a session management context;

in this step, the second MME identifies the second control network element to serve for a PGW, and the first MME identifies a first control network element to serve for an SGW;

Step 303: the first MME determines, according to a current access location of the UE, whether a first control network element is selected; when the current access location of the UE changes and the UE has exceeded a control area of the second control network element, the first MME selects a first control network element;

Step 304: the first MME sends to the first control network element a creation session request message to establish a GTP tunnel; the creation session request message includes an identification or address information of the second control network element;

Step 305: the first control network element determines a selected first SGW according to UE location information in the creation session request message, and the first control network element sends to the first SGW a flow table;

Step 306: the first control network element performs addressing according to the identification or the address information of the second control network element, acquires an address of a PGW and a TEID of the PGW allocated by the second control network element, and notifies to the second control network element an address of a first SGW and TEID information of the first SGW allocated thereby;

Step 307: the first control network element sends to the first SGW flow table information including the acquired address of the PGW and the acquired TEID information of the PGW, and indicates the first SGW to cache data when there is no downlink data path;

Step 308: the second control network element sends to the PGW flow table information including the acquired address of the first SGW and the acquired TEID information of the first SGW;

Step 309: when there are uplink data to be transmitted in the UE during the TAU process, the first MME establishes a bearer of an air interface, initiates an initial context setup process and acquires an address of a first eNB and a TEID of the first eNB;

Step 310: the first MME sends to the first control network element a modification bearer request message including the address of the first eNB and the TEID of the first eNB;

Step 311: the first control network element sends to the first SGW a flow table including the address of the first eNB and the TEID of the first eNB, and updates downlink GTP tunnel information;

Step 312: the second MME sends to the second control network element a deleting session request information;

Step 313: the second control network element deletes user flow table information in a second SGW by deleting the flow table information so as to recover resources.

### Embodiment 2

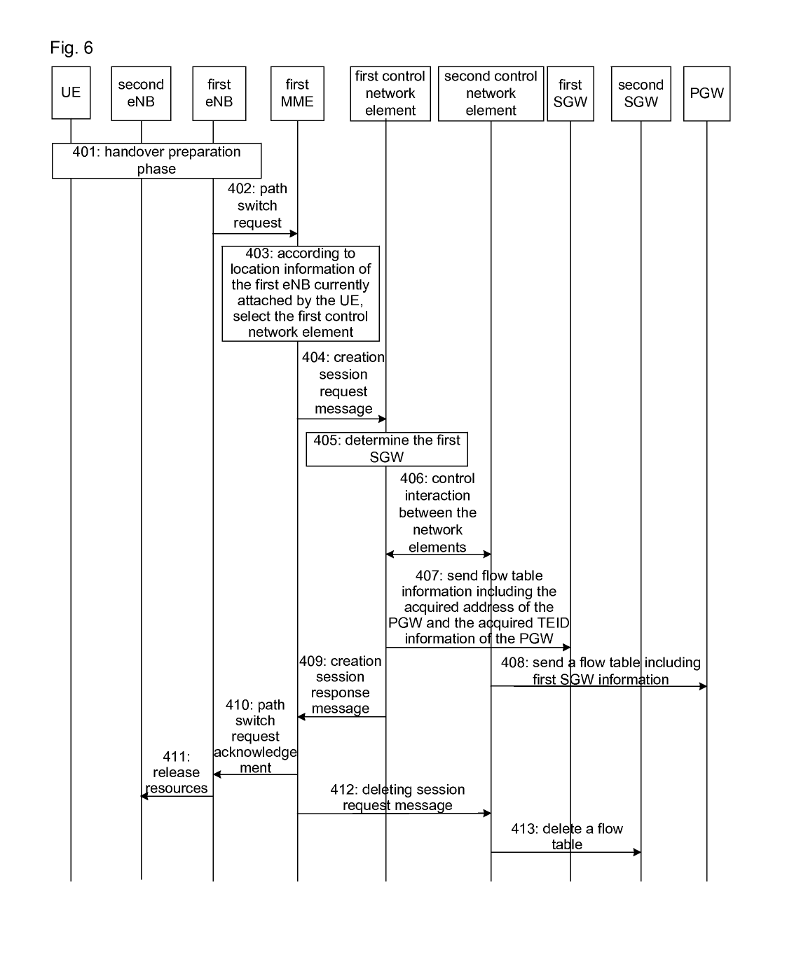

FIG. 6 shows a method for realizing mobility management of an EPC network in the embodiment. As shown in Fig, 6, the method includes:

Step 401: a second eNB determines, according to measurement information reported by a UE, that the second eNB cannot serve for the UE any more; the second eNB selects an appropriate first eNB to perform handover; wireless bearer information is interacted between the second eNB and the first eNB to reserve resources, and a handover preparation phase is finished;

Step 402: when being attached to the first eNB, the UE sends to a first MME a path switch request message to notify that a cell of the UE has changed;

Step 403: the first MME determines, according to location information of the first eNB currently attached by the UE, whether a first control network element is reselected; when the location information of the first eNB has exceeded a control area of the second control network element, the first MME selects a first control network element;

Step 404: the first MME sends to the first control network element a creation session request message to establish a GTP tunnel, wherein the message includes an identification or address information of the second control network element;

Step 405: the first control network element determines a first SGW according to location information of the UE in the creation session request message;

Step 406: the first control network element performs addressing according to the identification or the address information of the second control network element, acquires an address of a PGW and a TEID of the PGW allocated by the second control network element, and notifies to the second control network element an address of a first SGW and TEID information of the first SGW allocated thereby;

Step 407: the first control network element sends to the first SGW flow table information including the acquired address of the PGW and the acquired TEID information of the PGW;

Step 408: the second control network element sends to the PGW flow table information including the acquired address of the first SGW and the acquired TEID information of the first SGW;

Step 409: the first control network element sends to the first MME a creation session response message;

Step 410: the first MME returns a path switch request ACK message to acknowledge a handover success;

Step 411: the first eNB notifies the second eNB to release wireless resource information;

Step 412: the first MME sends to the second control network element a deleting session request message;

Step 413: the second control network element deletes user flow table information in a second SGW by deleting the flow table information so as to recover resources.

### Embodiment 3

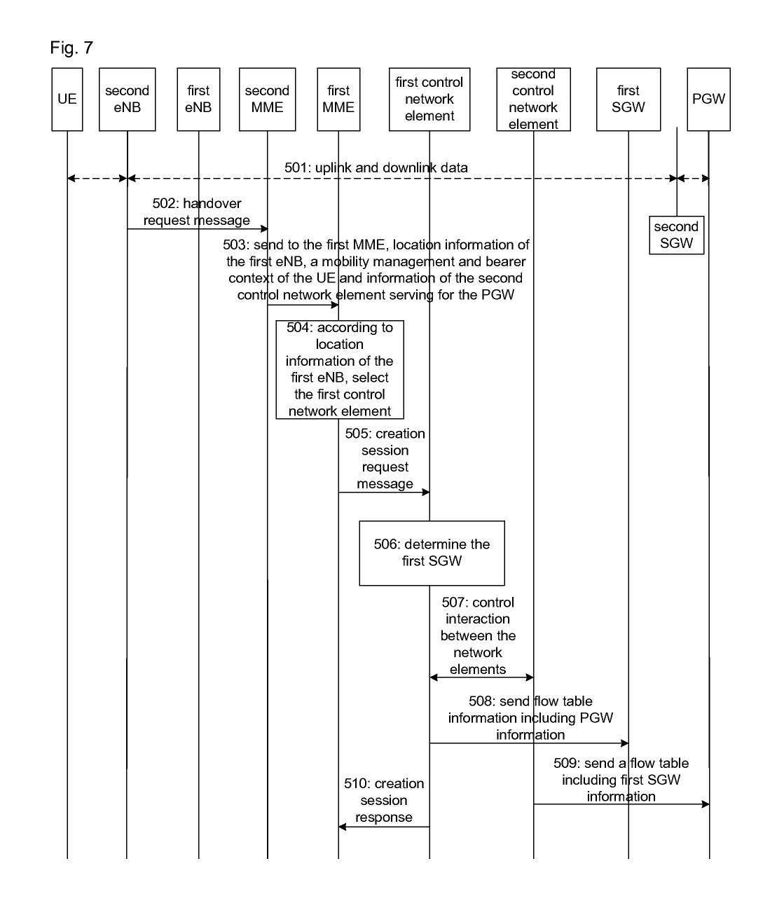

FIG. 7 shows a method for realizing mobility management of an EPC network in the embodiment. As shown in Fig, 7, the method includes:

Step 501: uplink and downlink data of a UE are transmitted among the UE, a second eNB and a second SGW;

Step 502: the second eNB determines, according to measurement information reported by the UE, that the second eNB cannot serve for the UE any more; the second eNB sends to a second MME a handover request message including identification information of a first eNB for handover;

Step 503: the second MME selects a first MME according to the identification information of the first eNB and a topological relation, and sends to the first MME location information of the first eNB, a mobility management and bearer context of the UE and information of a second control network element serving for a PGW;

Step 504: the first MME determines, according to the location information of the first eNB, whether a first control network element is reselected; when the location information of the first eNB has exceeded a control area of the second control network element, the first MME selects a first control network element;

Step 505: the first MME sends to the first control network element a creation session request message to establish a GTP tunnel, wherein the message includes an identification or address information of the second control network element;

Step 506: the first control network element determines a first SGW according to location information of the UE in the creation session request message;

Step 507: the first control network element performs addressing according to the identification or the address information of the second control network element, acquires an address of a PGW and a TEID of the PGW allocated by the second control network element, and notifies to the second control network element an address of a first SGW and a TEID of the first SGW allocated thereby;

Step 508: the first control network element sends to the first SGW flow table information including the acquired address of the PGW and the acquired TEID information of the PGW;

Step 509: the second control network element sends to the PGW flow table information including the acquired address of the first SGW and the TEID information of the first SGW;

Step 510: the first control network element replies to the first MME a creation session response message including the address of the first SGW and the TEID information of the first SGW.

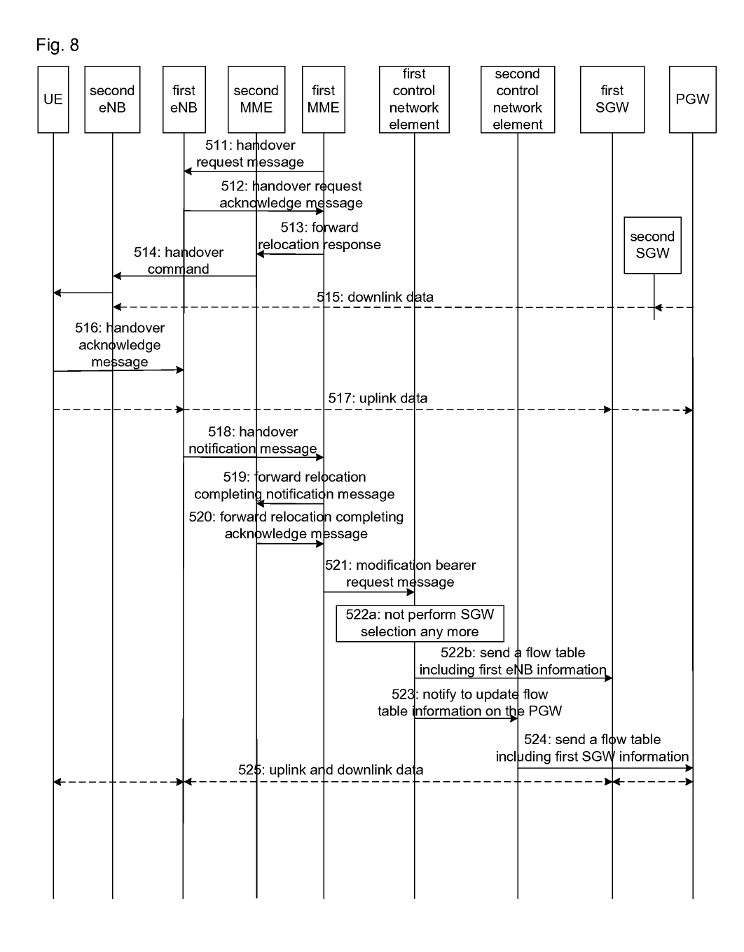

After Step 510, the embodiment further includes a process of direct data forwarding among base stations, as shown in FIG. 8, which includes:

Step 511: the first MME sends to the first eNB a handover request message to request for resource reservation; the message includes the address of the first SGW and the TEID information of the first SGW;

Step 512: the first eNB returns a handover request acknowledge message to notify to the first MME an address of the first eNB and TEID information of the first eNB;

Step 513: the first MME returns a forward relocation response message to notify the second MME that resources are reserved successfully at a target side;

Step 514: the second MME sends to the second eNB a handover command including address information of the first eNB so as to further notify the UE to initiate a handover to the first eNB;

Step 515: downlink data are sent to the second eNB through the second SGW to be further sent, through a direct forwarding tunnel, to the first eNB to be cached;

Step 516: after being synchronized to the first eNB, the UE sends a handover confirmation message to verify an air interface handover success;

Step 517: after the UE is switched to the first eNB, uplink data are sent to the PGW through the first eNB and the first SGW;

Step 518: the first eNB sends to the first MME a handover notification message including the address of the first eNB and the TEID of the first eNB;

Step 519: the first MME sends to the second MME a forward relocation completing notification message to notify the UE of a handover success;

Step 520: the second MME returns a forward relocation completing acknowledge message to release wireless resources of the second eNB;

Step 521: the first MME sends to the first control network element a modification bearer request message to update a downlink user plane, wherein the message includes the address of the first eNB and the TEID of the first eNB;

Step 522a to Step 522b: after receiving a GTP tunnel Completing (GTP-C) notification message, the first control network element no longer performs SGW selection and sends to the first SGW flow table information including the address of the first eNB and the TEID of the first eNB;

Step 523: the first control network element notifies the second control network element to update flow table information on the PGW;

Step 524: the second control network element sends to the PGW the acquired address of the first SGW and the acquired TEID of the first SGW;

Step 525: after tunnel updating, uplink and downlink data are transmitted among the first eNB, the first SGW and the PGW.

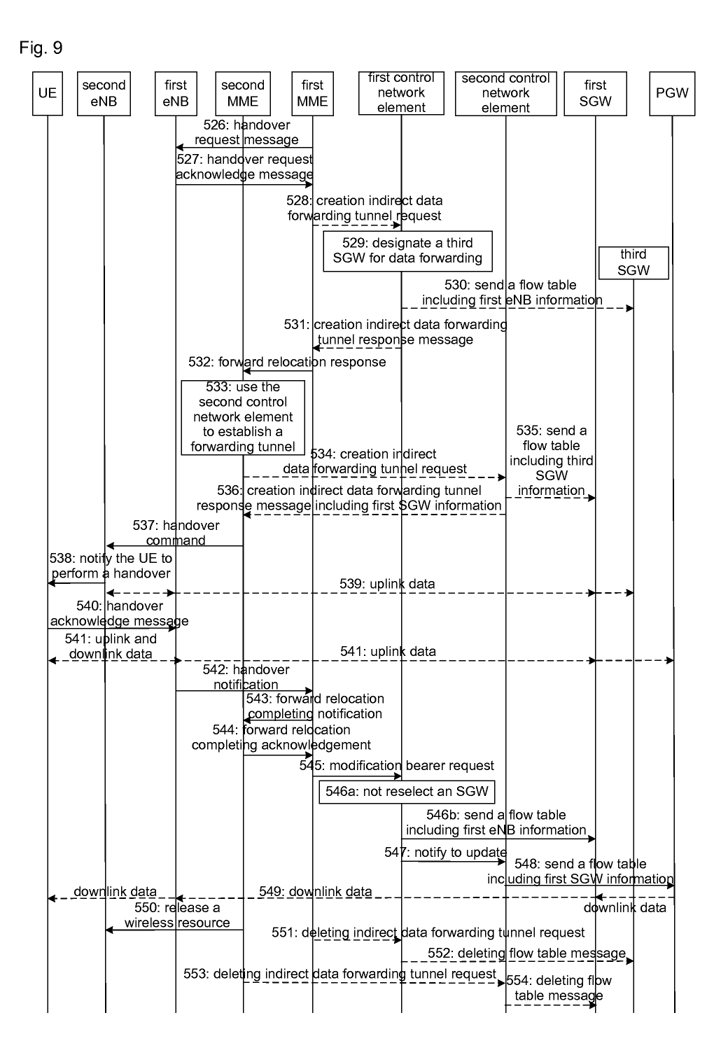

After Step 510, the embodiment may further include a process of indirect data forwarding among base stations, as shown in FIG. 9, which includes:

Step 526: the first MME sends to the first eNB a handover request message to request for resource reservation, wherein the handover message includes the address of the first SGW and the TEID of the first SGW;

Step 527: the first eNB returns a handover request acknowledge message to notify to the first MME the address of the first eNB and the TEID information of the first eNB, and resources are reserved successfully at a target side;

Step 528: the first MME sends to the first control network element a creation indirect data forwarding tunnel request message to establish a GTP data tunnel for indirect forwarding; the creation indirect data forwarding tunnel request message includes the address of the first eNB and the TEID information of the first eNB;

Step 529: the first control network element designates a third SGW for data forwarding;

Step 530: the first control network element sends to the third SGW a flow table to notify the address of the first eNB and the TEID information of the first eNB;

Step 531: the first control network element replies to the first MME a creation indirect data forwarding tunnel response message to notify to the first MME an address of the third SGW and TEID information of the third SGW;

Step 532: the first MME returns to the second MME a forward relocation response message, and notifies to the second MME the address of the third SGW and the TEID information of the third SGW;

Step 533: the second MME uses the second control network element or reselects a control network element to establish a forwarding tunnel; in the embodiment, the second MME uses the second control network element to establish the forwarding tunnel;

Step 534: the second MME sends to the second control network element a creation indirect data forwarding tunnel request message to notify to the second control network element the address of the third SGW and the TEID information of the third SGW;

Step 535: the second control network element notifies to the first SGW the address of the third SGW and the TEID information of the third SGW;

Step 536: the second control network element returns a creation indirect data forwarding tunnel response message to notify to the second MME the address of the first SGW and the TEID information of the first SGW;

Step 537: the second MME sends to the second eNB a handover command to notify the address of the first SGW and the TEID information of the first SGW;

Step 538: the second eNB notifies the UE to initiate a handover to the first eNB;

Step 539: uplink data are transmitted among the second eNB, the third SGW and the first eNB;

Step 540: after being synchronized to the first eNB, the UE sends a handover confirmation message;

Step 541: after the UE accesses the first eNB, uplink data and downlink data acquired through forwarding are transmitted uni-directionally among the UE, the first eNB, the first SGW and the PGW;

Step 542: the first eNB sends a handover notification message to the first MME to notify completion of an air interface handover;

Step 543: the first MME sends to the second MME a forward relocation completing notification message to notify a handover success to the UE;

Step 544: the second MME returns a forward relocation completing acknowledge message and releases wireless resources of the second eNB;

Step 545: the first MME sends to the first control network element a modification bearer request message to update a downlink user plane; the message includes the address of the first eNB and the TEID of the first eNB;

Step 546a to Step 546b: the first control network element receives a GTP-C notification message, no longer performs SGW selection, and sends to the first SGW flow table information including the address of the first eNB and the TEID of the first eNB;

Step 547: the first control network element notifies the second control network element to update flow table information on the PGW;

Step 548: the second control network element sends to the PGW the acquired address of the first SGW and the acquired TEID of the first SGW;

Step 549: after tunnel updating, downlink data are transmitted among the first eNB, the first SGW and the PGW;

Step 550: the second MME releases wireless bearer resources;

Step 551: after a forwarding timer expires, the first MME sends to the first control network element a deleting indirect data forwarding tunnel request message;

Step 552: the first control network element sends to the third SGW a deleting flow table message and recovers forwarding plane device resources;

Step 553: after a forwarding timer expires, the second MME sends to the first control network element a deleting indirect data forwarding tunnel request message;

Step 554: the second control network element sends a deleting flow table message to the first SGW for forwarding and recovers forwarding plane device resources.

The above are merely preferred embodiments of the disclosure, but are not intended to limit the protection scope of the disclosure.

### INDUSTRIAL APPLICABILITY

In the embodiments of the disclosure, when a control network element changes during a movement of a UE, a first control network element addresses a second control network element according to an identification or address information of the second control network element sent from a first MME, acquires an address of a PGW and TEID information of the PGW allocated by the second control network element, and sends to the second control network element an address of a first SGW and TEID information of the first SGW allocated thereby; the first control network element sends to the first SGW flow table information including the address of the PGW and the TEID information of the PGW; and the second control network element sends to the PGW flow table information including the address of the first SGW and the TEID information of the first SGW. Thus, coordination problems of two control network elements caused by changes of the control network elements due to the movement of the UE can be solved.

What is claimed is:

1. A method for realizing mobility management of an Evolved Packet Core (EPC) network, comprising:
when a control network element changes, addressing, by a first control network element, a second control network element according to an identification or address information of the second control network element sent from a first Mobility Management Entity (MME), acquiring an address of a Public Data Network (PDN) Gateway (PGW) and Tunnel Endpoint Identification (TEID) information of the PGW allocated by the second control network element, and sending to the second control network element an address of a first Serving Gateway (SGW) and TEID information of the first SGW allocated thereby;
sending, by the first control network element, to the first SGW flow table information including the address of the PGW and the TEID information of the PGW; and
sending, by the second control network element, to the PGW flow table information including the address of the first SGW and the TEID information of the first SGW.

2. The method according to claim 1, further comprising: selecting, by the first MME, the first control network element according to a current access location of a User Equipment (UE) or location information of a first Evolved NodeB (eNB), and sending to the selected first control network element a creation session request message to establish a General Packet Radio Service (GPRS) Tunneling Protocol (GTP) tunnel, wherein the creation session request message includes location information of the UE, and the identification or the address information of the second control network element.

3. The method according to claim 2, further comprising: before selecting the first control network element by the first MME,
after the UE leaves an area defined by a Tracking Area Identity (TAI) list, selecting, by the first eNB, the first MME for the UE; sending, by the UE, to the first MME a Tracking Area Update (TAU) request; finding, by the first MME, a second MME according to a Globally Unique Temporary UE Identity (GUTI) and sending to the second MME a context acquisition message; replying, by the second MME, to the first MME context information of the UE and information of the second control network element serving for the UE;
or, determining, by a second eNB, that the second eNB cannot serve for the UE any more according to measurement information reported by the UE; sending, by the second eNB, to the second MME a handover request message including identification information of the first eNB for handover; selecting, by the second MME, the first MME according to the identification information of the first eNB and a topological relation, and sending to the first MME the location information of the first eNB, a mobility management and bearer context of the UE and information of the second control network element serving for the PGW.

4. The method according to claim 3, further comprising: when there are uplink data to be sent in the UE during a TAU process, establishing, by the first MME, a bearer of an air interface and initiating an initial context setup process to acquire an address of the first eNB and a TEID of the first eNB; sending, by the first MME, to the first control network element a modification bearer request message including the address of the first eNB and the TEID of the first eNB; sending, by the first control network element, to the first SGW a flow table including the address of the first eNB and the TEID of the first eNB and updating downlink GTP tunnel information.

5. The method according to claim 3, further comprising: when data between base stations need to be forwarded directly, acquiring, by the first control network element, from the first MME an address of the first eNB and a TEID of the first eNB, sending the flow table information including the address of the first eNB and the TEID of the first eNB to the first SGW, and notifying the second control network element to update the flow table information on the PGW; after receiving the notification, sending, by the second control network element, the acquired address of the first SGW and the acquired TEID information of the first SGW to the PGW; updating, by the PGW, flow table information of itself according to the address of the first SGW and the TEID information of the first SGW; after the updating, transmitting uplink and downlink data among the first eNB, the first SGW and the PGW.

6. The method according to claim 3, further comprising: when uplink data between base stations need to be forwarded indirectly, acquiring, by the first control network element, from the first MME an address of the first eNB and a TEID of the first eNB, designating a third SGW for forwarding data and sending to the third SGW a flow table including the address of the first eNB and the TEID of the first eNB; sending, by the first control network element, to the first MME an address of the third SGW and a TEID of the third SGW; forwarding, by the first MME, to the second MME the address of the third SGW and the TEID of the third SGW; notifying, by the second MME, the address of the third SGW and the TEID of the third SGW to the second control network element and the second eNB; notifying, by the second control network element, the address of the third SGW and the TEID of the third SGW to the first SGW; and transmitting the uplink data among the second eNB, the third SGW and the first eNB.

7. The method according to claim 3, further comprising: when downlink data between base stations need to be forwarded indirectly, acquiring, by the first control network element, from the first MME an address of the first eNB and a TEID of the first eNB, sending the flow table information including the address of the first eNB and the TEID of the first eNB to the first SGW, and notifying the second control network element to update the flow table information on the PGW; after receiving the notification, sending, by the second control network element, to the PGW the acquired address of the first SGW and the acquired TEID of the first SGW; updating, by the PGW, flow table information of itself according to the address of the first SGW and the TEID information of the first SGW; after the updating, transmitting the downlink data among the first eNB, the first SGW and the PGW.

8. The method according to claim 3, further comprising: sending, by the first MME or the second MME, to the second control network element a deleting session request message; deleting, by the second control network element, user flow table information in the second SGW by deleting the flow table information to recover resources.

9. A system for realizing mobility management of an Evolved Packet Core (EPC) network, comprising: a first control network element, a second control network element, a first Mobility Management Entity (MME), a first Serving Gateway (SGW) and a Public Data Network (PDN) Gateway (PGW), wherein
the first control network element is configured to address the second control network element according to an identification or address information of the second control network element sent from the first MME, to acquire an address of the PGW and Tunnel Endpoint Identification (TEID) information of the PGW allocated by the second control network element, and to send to the second control network element an address of the first SGW and TEID information of the first SGW allocated thereby; and to send to the first SGW flow table information including the address of the PGW and the TEID information of the PGW;
the second control network element is configured to send to the PGW flow table information including the address of the first SGW and the TEID information of the first SGW.

10. The system according to claim 9, further comprising a first Evolved NodeB (eNB) which is configured to be attached by a User Equipment (UE);
the first MME is configured to select the first control network element according to a current access location of the UE or location information of the eNB, and to send to the selected first control network element a creation session request message to establish a General Packet Radio Service (GPRS) Tunneling Protocol (GTP) tunnel, wherein the creation session request message includes location information of the UE, and the identification or the address information of the second control network element.

11. The system according to claim 9, further comprising: a second MME which is configured to reply to the first MME context information of the UE and information of the second control network element serving for the UE;
the first eNB is further configured to select the first MME for the UE;
the first MME is further configured to find the second MME according to a Globally Unique Temporary UE Identity (GUTI) and to send to the second MME a context acquisition message;
or, further comprising: a second eNB and a second MME, wherein
the second eNB is configured to determine, according to measurement information reported by the UE, that the second eNB cannot serve for the UE any more; and to send to the second MME a handover request message including identification information of the first eNB for handover;
the second MME is configured to select the first MME according to the identification information of the first eNB and a topological relation, and to send to the first MME the location information of the first eNB, a mobility management and bearer context of the UE and information of the second control network element serving for the PGW.

12. The system according to claim 11, wherein the first MME is further configured, when there are uplink data to be sent in the UE during a TAU process, to establish a bearer of an air interface, and to initiate an initial context setup process to acquire an address of the first eNB and a TEID of the first eNB; and to send to the first control network element a modification bearer request message including the address of the first eNB and the TEID of the first eNB;
accordingly, the first control network element is further configured to send to the first SGW a flow table including the address of the first eNB and the TEID of the first eNB, and to update downlink GTP tunnel information.

13. The system according to claim 11, wherein the first control network element is further configured, when data between base stations need to be forwarded directly, to acquire from the first MME an address of the first eNB and a TEID of the first eNB, to send the flow table information including the address of the first eNB and the TEID of the first eNB to the first SGW, and to notify the second control network element to update the flow table information on the PGW;
accordingly, the second control network element is further configured, after receiving the notification, to send the acquired address of the first SGW and the acquired TEID information of the first SGW to the PGW;
accordingly, the PGW is configured to update flow table information of itself according to the address of the first SGW and the TEID information of the first SGW; after the updating, uplink and downlink data are transmitted among the first eNB, the first SGW and the PGW.

14. The system according to claim 11, wherein the first control network element is further configured, when uplink data between base stations need to be forwarded indirectly, to acquire from the first MME an address of the first eNB and a TEID of the first eNB, to designate a third SGW for forwarding data, and to send to the third SGW a flow table including the address of the first eNB and the TEID of the first eNB; and to send to the first MME an address of the third SGW and a TEID of the third SGW;
accordingly, the first MME is further configured to forward to the second MME the address of the third SGW and the TEID of the third SGW;
accordingly, the second MME is configured to notify the address of the third SGW and the TEID of the third SGW to the second control network element and the second eNB;
accordingly, the second control network element is further configured to notify the address of the third SGW and the TEID of the third SGW to the first SGW; and the uplink data are transmitted among the second eNB, the third SGW and the first eNB.

15. The system according to claim 11, wherein the first control network element is further configured, when downlink data between base stations need to be forwarded indirectly, to acquire from the first MME an address of the first eNB and a TEID of the first eNB, to send the flow table information including the address of the first eNB and the TEID of the first eNB to the first SGW, and to notify the second control network element to update the flow table information on the PGW;
accordingly, the second control network element is further configured, after receiving the notification, to send to the PGW the acquired address of the first SGW and the acquired TEID of the first SGW;
accordingly, the PGW is configured to update flow table information of itself according to the address of the first SGW and the TEID information of the first SGW; after the updating, the downlink data are transmitted among the first eNB, the first SGW and the PGW.

16. The system according to claim 11, further comprising a second SGW; the first MME or the second MME is further configured to send to the second control network element a deleting session request message;
accordingly, the second control network element is further configured to delete user flow table information in the second SGW by deleting the flow table information to recover resources.
